(19) United States
(12) Patent Application Publication
(10) Pub. No.: US 2009/0066986 A1
(43) Pub. Date: Mar. 12, 2009

(54) IMAGE FORMING APPARATUS, INFORMATION PROCESSING APPARATUS, AND IMAGE FORMING METHOD

(75) Inventors: Daisuke Miyagi, Aichi (JP); Kazuma Ogawa, Nara (JP); Kenji Onogi, Onogi (JP)

Correspondence Address: EDWARDS ANGELL PALMER & DODGE LLP, P.O. BOX 55874, BOSTON, MA, 02205, US

(73) Assignee: SHARP KABUSHIKI KAISHA, Osaka (JP)

(21) Appl. No.: 12/194,023

(22) Filed: Aug. 19, 2008

(30) Foreign Application Priority Data
Sep. 7, 2007 (JP) 2007-232846

(51) Int. Cl. G06F 3/12

(52) U.S. Cl. 358/1.13; 358/1.15

(57) ABSTRACT

An MFP includes a printing portion, a print pattern setting portion, a print pattern conversion portion that carries out conversion into a set print pattern for each color composing the image data having undergone a gradation change when printing is carried out at a gradation different from that of input image data, a display portion that displays a preview of the converted image data, and an image processing portion that lets a user give an instruction on whether or not to execute printing of the image data after a preview of the image data is displayed. When no instruction to execute printing is given, the print pattern setting portion causes the display portion to display a plurality of other print patterns different from a print pattern added to the image data to let the user select a desired print pattern out of the plurality of other print patterns.

### CROSS-NOTING PARAGRAPH

This Nonprovisional application claims priority under 35 U.S.C. §119 (a) on Patent Application No. 2007-232846 filed in JAPAN on Sep. 7, 2007, the entire contents of which are hereby incorporated herein by references.

### FIELD OF THE INVENTION

The present invention relates generally to an image forming apparatus, an information processing apparatus, and an image forming method, and, more particularly, to an image forming apparatus having such a plurality of functions as a copy function, a printer function, and a facsimile function, an information processing apparatus connected to the image forming apparatus, and an image forming method.

### BACKGROUND OF THE INVENTION

Various application software having functions of document making, spread sheet programs, etc., is used in an information processing apparatus, such as a PC (Personal Computer). Such application software usually offers color display performance these days, enabling color display of various data made by the software. This sufficiently improves data visibility and user convenience in the use of the information processing apparatus.

A color printer having a function of color printing a color image output from a PC or read by a scanner has come into wide use. Usually, signals input from a PC or scanner are R (red), G (green), and B (blue) signals. The color printer converts these R, G, and B signals into M (magenta), C (cyan), and K (black) signals and prints out the converted signals.

Such color printers includes a specific printer that carries out a color-reducing process on the original input color image and that prints out the color image reduced in color. Such a printer performs thickness expression by converting a luminance element of a color image signal into thickness data. Because of this, for example, when color image signals have different hue elements, such as blue and red elements, but the same luminance element, the same thickness expression results to make both color image signals hardly distinguishable, which poses a problem.

With respect to this problem, a printing apparatus capable of distinguishing areas set to different colors in a color image is described in Japanese Laid-Open Patent Publication No. 08-39921. According to this printing apparatus, a color separating circuit separates color image signals in color to R, G, and B signals pixel by pixel, and a control portion converts the R, G, and B signals into color identification signals and determines whether the same color identification signal presents in succession in a given dimension or larger dimension. When the same color identification signal presents in succession in the given dimension or larger dimension, a selector in the control portion selects any one of pattern data #0 to #7 input from a pattern data memory, based on the color identification signal, and outputs selected pattern data as print data to a printing portion, which carries out pattern printing.

The printing apparatus described in Japanese Laid-Open Patent Publication No. 08-39921 selects any one of the predetermined pattern data #0 to #7 to carry out printing when printing out an image reduced in color from the original color image. These pattern data, however, are each fixed to each color, which prevents a user from freely selecting and setting a piece of pattern data.

Because of this, for example, the user is not allowed to freely select a replacing print pattern according to the hue and size (dimension) of a monochromatic part contained in a color image, which leads to output of a printed matter that lacks expressiveness. The above printing apparatus is, therefore, not applicable to printing of presentation materials, etc., that requires expressiveness in particular.

### SUMMARY OF THE INVENTION

An object of the present invention is to provide an image forming apparatus, an information processing apparatus, and an image forming method that when monochromatic parts having the same color or similar hues are present at a plurality of spots, can set user-desiring print patterns for the monochromatic parts when color-reducing printing of a color image is carried out.

Another object of the present invention is to provide an image forming apparatus having an input portion that inputs image data and a printing portion that prints the input image data, the image forming apparatus comprising a print pattern setting portion that sets a print pattern available for user setting for each color; a print pattern conversion portion that carries out conversion into a print pattern set by the print pattern setting portion for each color composing the image data having undergone a gradation change when printing is carried out at a gradation different from that of image data input by the input portion; a display portion that displays a preview of the image data converted by the print pattern conversion portion; and a print execution instructing portion that lets a user give an instruction on whether or not to execute printing of the image data after preview display by the display portion or test printing by the printing portion is carried out, wherein when an instruction to execute printing is given, the printing portion starts a process of printing the image data, and wherein when no instruction to execute printing is given, the print pattern setting portion causes the display portion to display a plurality of other print patterns different from a print pattern added to the image data to let the user select a desired print pattern out of the plurality of other print patterns.

Another object of the present invention is to provide the image forming apparatus, wherein image data input by the input portion represents a color image, and image data printed by the printing portion represents a monochrome image or a color image created by color reduction from the color image.

Another object of the present invention is to provide the image forming apparatus, wherein when a plurality of areas having specific colors and given dimensions or larger dimensions are present in color-reduced image data created by color reduction from image data input by the input portion, the print pattern conversion portion carries out conversion into a print pattern set by the print pattern setting portion for each of colors of the areas.

Another object of the present invention is to provide the image forming apparatus, comprising a counting portion that counts number of pixels of each color composing the color-reduced image data, wherein a dimension of the each color is calculated based on number of pixels counted by the counting portion.

Another object of the present invention is to provide the image forming apparatus, wherein the print pattern setting portion sets a print pattern according to a dimension of each color composing the color-reduced image data.

Another object of the present invention is to provide the image forming apparatus, wherein the print pattern setting portion sets a different print pattern according to number of reduced colors in the color-reduced image data.

Another object of the present invention is to provide the image forming apparatus, wherein when image data input by the input portion represents a nature image including a person and scenery, the print pattern conversion portion does not carry out a process of conversion into a print pattern on a monochromatic area in color-reduced image data created by color reduction from the nature image.

Another object of the present invention is to provide an information processing apparatus connectible to an image forming apparatus that prints image data, the information processing apparatus comprising: an image forming portion that generates image data; a print instructing portion that instructs the image forming apparatus to print the generated image data; a print pattern setting portion that sets a print pattern available for user setting for each color; a print pattern conversion portion that carries out conversion into a print pattern set by the print pattern setting portion for each color composing the image data having undergone a gradation change when a print instruction is issued for printing at a gradation different from that of image data generated by the image forming portion; a display portion that displays a preview of the image data converted by the print pattern conversion portion; and a print execution instructing portion that lets a user give an instruction on whether or not to execute printing of the image data after preview display by the display portion or test printing by the image forming apparatus is carried out, wherein when an instruction to execute printing is given, the print instructing portion causes the image forming apparatus to start an process of printing the image data, and wherein when no instruction to execute printing is given, the print pattern setting portion causes the display portion to display a plurality of other print patterns different from a print pattern added to the image data to let the user select a desired print pattern out of the plurality of other print patterns.

Another object of the present invention is to provide the information processing apparatus, wherein image data generated by the image forming portion represents a color image, and image data to be printed by an instruction from the print instructing portion represents a monochrome image or a color image created by color reduction from the color image.

Another object of the present invention is to provide the information processing apparatus, wherein when a plurality of areas having specific colors and given dimensions or larger dimensions are present in color-reduced image data created by color reduction from image data generated by the image forming portion, the print pattern conversion portion carries out conversion into a print pattern set by the print pattern setting portion for each of colors of the areas.

Another object of the present invention is to provide the information processing apparatus, comprising a counting portion that counts number of pixels of each color composing the color-reduced image data, wherein a dimension of the each color is calculated based on number of pixels counted by the counting portion.

Another object of the present invention is to provide the information processing apparatus, wherein the print pattern setting portion sets a different print pattern according to a dimension of each color composing the color-reduced image data.

Another object of the present invention is to provide The information processing apparatus, wherein the print pattern setting portion sets a different print pattern according to number of reduced colors in the color-reduced image data.

Another object of the present invention is to provide the information processing apparatus, wherein when image data generated by the image forming portion represents a nature image including a person and scenery, the print pattern conversion portion does not carry out a process of conversion into a print pattern on a monochromatic area in color-reduced image data created by color reduction from the nature image.

Another object of the present invention is to provide an image forming method carried out by an image forming apparatus that inputs image data and prints the input image data, the image forming method comprising: a print pattern setting step of setting a print pattern available for user setting for each color; a print pattern conversion step of carrying out conversion into a print pattern set at the print pattern setting step for each color composing the image data having undergone a gradation change, when printing is carried out at a gradation different from that of the input image data; a display step of displaying a preview of the image data converted at the print pattern conversion step; and a print execution instructing step of letting a user give an instruction on whether or not to execute printing of the image data after display of a preview of the image data or test printing of the image data is carried out, wherein when an instruction to execute printing is given, the method causes the image forming apparatus to start a process of printing the image data, and wherein when no instruction to execute printing is given, the method causes the image forming apparatus to display a plurality of other print patterns different from a print pattern added to the image data to let the user select a desired print pattern out of the plurality of other print patterns.

### BRIEF DESCRIPTION OF THE DRAWINGS

FIG. 1 is a block diagram showing an exemplary configuration of the principal part of an image forming system including an image forming apparatus and an information processing apparatus of the present invention;

FIG. 2 depicts an example of a conversion table of print patterns that correspond to individual hues and the dimensions of monochromatic print areas;

FIG. 3 depicts an example of print pattern data shown in FIG. 1;

FIGS. 4A and 4B depict examples of the print pattern data shown in FIG. 1;

FIG. 5 depicts an example of a screen for prompting a user to confirm print execution following execution of preview display or test printing of image data to which a print pattern is assigned;

FIG. 6 is a flowchart for explaining an example of an image forming method carried out by an MFP of the present invention;

FIG. 7 depicts an example of a case where a color image is reduced in color to a gradation image; and

FIG. 8 depicts an example of image data that is output as a result of assigning print patterns to the gray scale image of FIG. 7 and converting the gray scale image.

### PREFERRED EMBODIMENTS OF THE INVENTION

Preferred embodiments of an image forming apparatus, an information processing apparatus, and an image forming method of the present invention will now be described with reference to the accompanying drawings.

### First Embodiment

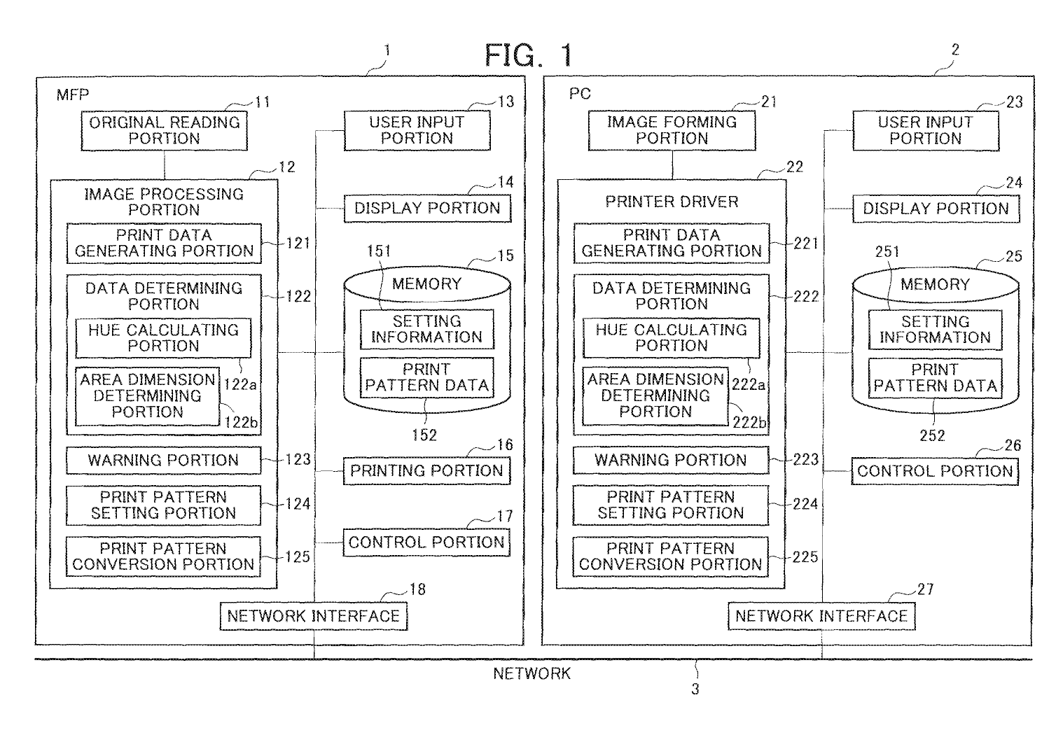

FIG. 1 is a block diagram showing an exemplary configuration of the principal part of an image forming system including the image forming apparatus and the information processing apparatus of the present invention. In FIG. 1, 1 denotes the image forming apparatus (hereinafter “MFP”), 2 denotes the information processing apparatus (hereinafter “PC”), and 3 denotes a network. The MFP 1 is the digital multifunction peripheral having a copy function, a printer function, a facsimile function, and a scanner function, and is connected to the PC 2 via the network 3.

The MFP 1 includes an original reading portion 11 capable of reading an original image in a plurality of colors to input color image data, an image processing portion 12 that carries out an image process on image data input from the original reading portion 11 or the PC 2, a user input portion 13 having a touch panel, operating keys, numeric keys, etc., for user operation, a display portion 14 having a liquid crystal display capable of displaying various information on print preview, etc., a memory 15 provided as a hard disc, etc., that has stored thereon image data, etc., a printing portion 16 that prints out a monochrome or color image out of image data processed at the image processing portion 12, a control portion 17 that has a CPU, memory, etc., that control the overall operation of the MFP 1, and a network interface 18 that is connected to the network 3 provided as a LAN, the Internet, etc., for inputting image data from the PC 2 to the MFP 1.

Description will be made of a case where a color-reduced image is printed out of the original image data for the reason of user setting, toner shortage in the MFP 1, etc. In this case, image data read and input by the original reading portion 11 or image data input from the PC 2 via the network interface 18 is color image data, and image data printed by the printing portion 16 is monochrome image data or color image data created by color reduction from the input image data.

The main feature of the MFP 1 of the present invention is that when monochromatic parts having the same hue or similar hues are present at a plurality of spots, the MFP 1 sets user-desiring print patterns for the monochromatic parts when printing out a color-reduced image out of a color image.

To offer its configuration, the MFP 1 includes the original reading portion 11 or the network interface 18 that is equivalent to an input portion that inputs image data (hereinafter “original reading portion 11”), the printing portion 16 that prints input image data, a print pattern setting portion 124 that sets a print pattern available for user setting for each color, a print pattern conversion portion 125 that carries out conversion into a print pattern set by the print pattern setting portion 124 for each color composing the image data having undergone a gradation change when printing is carried out at a gradation different from that of image data input from the original reading portion 11, the display portion 14 that displays a preview of the image data converted by the print pattern conversion portion 125, and the image processing portion 12 equivalent to a print execution instructing portion that lets the user give an instruction on whether or not to execute printing of the image data after preview display by the display portion 14 or test printing by the printing portion 16 is carried out.

When the user gives an instruction to execute printing, the printing portion 16 starts an image data print process with print patterns resulting from conversion by the print pattern conversion portion 125. When the user does not give an instruction to execute printing, on the other hand, the print pattern setting portion 124 causes the display portion 14 to display a plurality of other print patterns different from a print pattern added to the image data to let the user select a desired print pattern out of the plurality of other print patterns.

The image processing portion 12 has a print data generating portion 121, a data determining portion 122, and a warning portion 123, and also has the above print pattern setting portion 124 and print pattern conversion portion 125. The data determining portion 122 has a hue calculating portion 122a and an area dimension determining portion 122b.

The print data generating portion 121 converts color image data input from the original reading portion 11 into printable data, and carries out a prescribed color-reducing process on the image data. Through this color-reducing process, each of hues (color signals) composing the color image data is converted into, for example, any one of hues of C, M, Y, K, R, G, and B. The resulting image data is color-reduced image data.

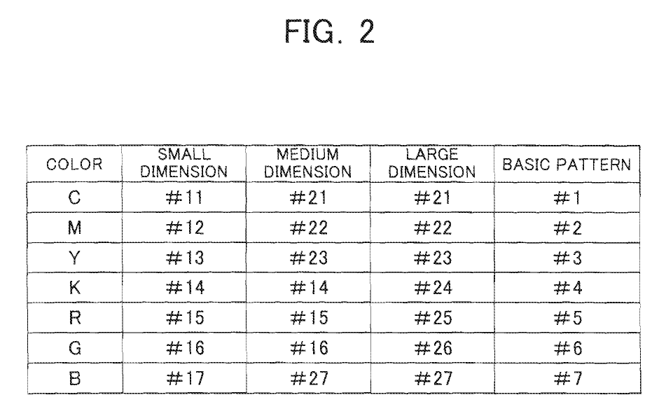

The data determining portion 122 determines whether areas having specific colors and given dimensions are present at a plurality of spots in color-reduced image data created by color reduction from input image data. For example, when specific colors are C, M, Y, K, R, G, and B, different print patterns are assigned to each of these specific colors, as shown in FIG. 2 to be described later. For example, when two areas having different hues of C and M are generated as a result of reducing the input image data in color, both areas become indistinguishable if the luminance elements of both areas are the same. Converting the areas having hues of C and M into different print patterns, however, facilitates distinguishing one area from another.

When determining through the above determination process that areas having specific colors and given dimensions are present at a plurality of spots in color-reduced image data, the data determining portion 122 instructs the print pattern conversion portion 125 to carry out a process of converting each of the areas into a print pattern corresponding to each color of the area.

The hue calculating portion 122a calculates in pixels each of hues (e.g., C, M, Y, K, R, G, and B) contained in color-reduced image data resulting from color reduction.

The area dimension determining portion 122b calculates the dimension of each hue calculated by the hue calculating portion 122a. The area dimension determining portion 122b has a counting portion (not shown) that counts number of pixels of each hue composing color-reduced image data, and calculates the dimension of each hue based on number of pixels counted by the counting portion.

The data determining portion 122 excludes an image area that is determined to be a nature image including a person and scenery, from the subject of a print pattern conversion process. Specifically, when image data input from the original reading portion 11 represents a nature image including a person and scenery, the print pattern conversion portion 125 does not carry out the process of conversion into a print pattern on a monochromatic area in color-reduced image data created by color reduction from that nature image.

The warning portion 123 outputs a warning indication on the display portion 14 when the data determining portion 122 issues an instruction of executing the print pattern conversion process.

Receiving the instruction of executing the print pattern conversion process from the data determining portion 122, the print pattern conversion portion 125 replaces a colored area to be converted into a print pattern with the corresponding print pattern. At this time, the print pattern replaces the area after being changed in color in adjustment to output after color reduction.

The memory 15 has stored thereon setting information 151 on setting of a print pattern, and a plurality of printable print pattern data 152 that correspond to individual hues. Upon carrying out the process of conversion into a print pattern, the image processing portion 12 refers to the setting information 151 and print pattern data 152 stored on the memory 15, and carries out conversion into a print pattern that corresponds to each color of color-reduced image data.

FIG. 2 depicts an example of a conversion table of print patterns that correspond to individual hues and the dimensions of monochromatic print areas. This print pattern conversion table is contained in the setting information 151, and is stored on the memory 15.

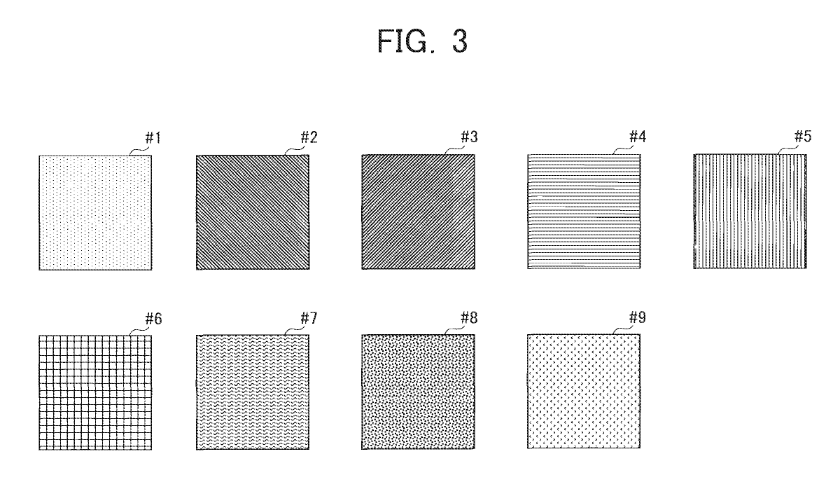

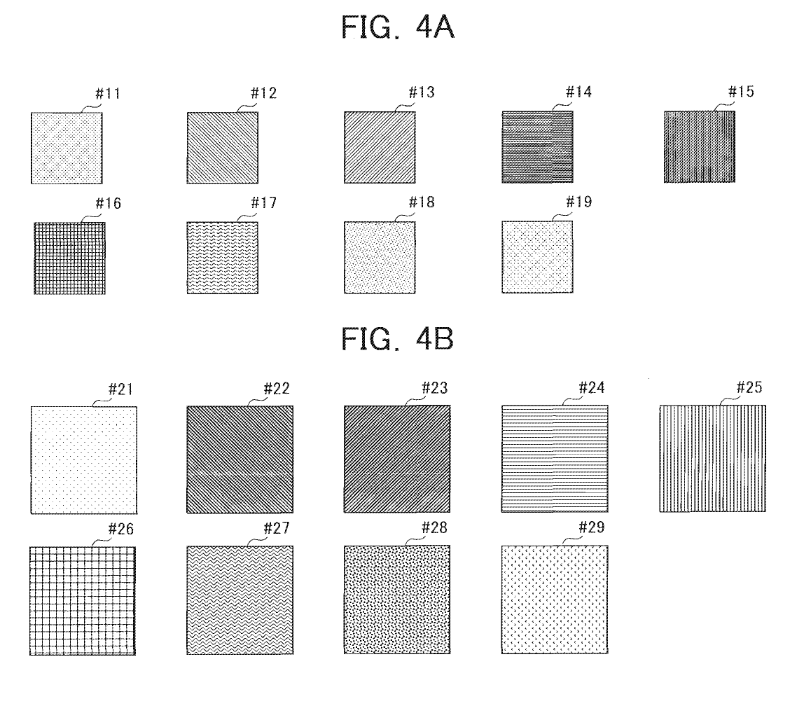

FIG. 3 and FIGS. 4A and 4B depict examples of the print pattern data 152 of FIG. 1.

The print pattern conversion table of FIG. 2 indicates the corresponding relation between basic print patterns (#1 to #7) for the respective hues (C, M, Y, K, R, G, and B) of color-reduced image data and print patterns (#11 to #17 and #21 to #27) corresponding to the dimensions of monochromatic areas. These basic print patterns (#1 to #7) and print patterns (#11 to #17 and #21 to #27) correspond to the print pattern data of FIG. 3 or that of FIGS. 4A and 4B.

A plurality of basic print patterns may be entered in correspondence to every hue on the print pattern conversion table. It is predetermined in this case which basic print pattern is to be used in a default situation. When the user changes default basic print patterns to desired print patterns, the user may change the default basic print patterns all at once or individually in hues. In the latter case, a changed print pattern may be entered by overwriting as a default basic print pattern, or may be newly entered as an additional basic print pattern different from a default basic print pattern.

Each of the basic print patterns #1 to #9 of FIG. 3 is assigned to each of hues, not depending on an area dimension. The print patterns #11 to #19 of FIG. 4A and the print patterns #21 to #29 of FIG. 4B are the result of conversion of the basic print patterns #1 to #9 depending on area dimensions. For example, the print pattern #11 of FIG. 4A is given by converting the print pattern #1 into a pattern for an area of a small dimension and assigning the converted pattern to the area of the small dimension, and the print pattern #21 of FIG. 4B is given by converting the print pattern #1 into a pattern for an area of a large dimension and assigning the converted pattern to the area of the large dimension. Other print patterns of various sizes are also given in the same manner.

In FIG. 2, a threshold for “small dimension”, that for “medium dimension”, and that for “large dimension” on the print pattern conversion table are determined to be, for example, 10 pixels or more to less than 50 pixels, 50 pixels or more to less than 100 pixels, and 100 pixels or more, respectively, and the determined thresholds are included in the setting information 151. Areas to be converted into print patterns are assumed. The assumed areas consist of an area C1 having a hue of C (cyan) and with a dimension of 300 pixels, an area C2 having a hue of C (cyan) and with a dimension of 40 pixels, and an area M1 having a hue of M (magenta) and with a dimension of 150 pixels. In this case, according to the setting of the print pattern conversion table of FIG. 2, the print pattern #21 is selected for the area C1, the print pattern #11 is selected for the area C2, and the print pattern #22 is selected for the area M1.

In this manner, a print pattern can be set on the print pattern conversion table in correspondence to the dimension of each color composing color-reduced image data. This setting process is carried out by the print pattern setting portion 124 of FIG. 1. Following user operation, the print pattern setting portion 124 causes the display portion 14 to display the print pattern conversion table, and lets the user select a print pattern in correspondence to the dimension of each color of the color-reduced image data. In user selection, if selectable print patterns are displayed on the display portion 14, the user is able to select a desired print pattern easily and quickly, which is preferable. Based on a user selection result, the print pattern setting portion 124 rewrites the contents of the print pattern conversion table and sets a print pattern on the table.

On the print pattern conversion table, a different print pattern may be set according to the number of reduced colors in color-reduced image data. The more the number of reduced colors, the harder making a distinction between areas reduced in colors. Changing a print pattern, therefore, facilitates making a distinction between areas. Similar to the above case, this setting process is carried out by the print pattern setting portion 124. Following user operation, the print pattern setting portion 124 causes the display portion 14 to display the print pattern conversion table, and lets the user select a different print pattern in correspondence to the number of reduced colors in the color-reduced image data. Based on a user selection result, the print pattern setting portion 124 rewrites the contents of the print pattern conversion table and sets a print pattern on the table. In this case, for example, a threshold is set for “small number of reduced color”, for “medium number of reduced color”, and for “large number of reduced color”, instead of being set for “small dimension”, for “medium dimension”, and for “large dimension” shown in FIG. 2, on the print pattern conversion table. A different print pattern is set for each of “small number of reduced color”, “medium number of reduced color”, and “large number of reduced color” in correspondence to each color of the color-reduced image data.

Referring to FIG. 1, the display portion 14 incorporated in the MFP 1 has a function of displaying a preview of image data that is converted by the print pattern conversion portion 125. As a result, the user is allowed to confirm print patterns of the image data through the preview displayed by the display portion 14 or test printing by the printing portion 16 before execution of a process of printing the image data to which the print patterns are added.

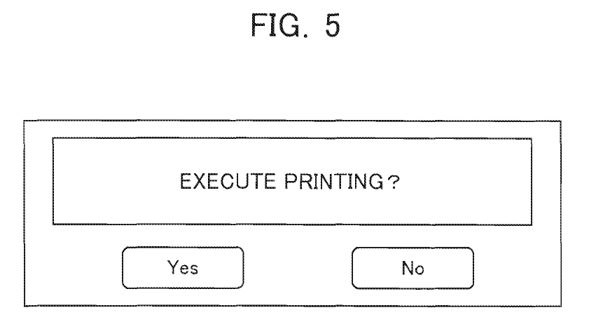

FIG. 5 depicts an example of a screen for prompting a user to confirm print execution following execution of preview display or test printing of image data to which a print pattern is assigned.

As described above, the MFP 1 has the print execution instructing portion that lets the user give an instruction on whether or not to execute printing of image data after preview display by the display portion 14 or test printing by the printing portion 16 is carried out. The print execution instructing portion is activated by the image processing portion 12, displaying the screen that prompts the user to make a confirmation on whether or not to execute printing, as shown in FIG. 5. When the image processing portion 12 issues an instruction to execute printing, the printing portion 16 starts an image data printing process.

When the image processing portion 12 does not issue an instruction to execute printing, the print pattern setting portion 124 causes the display portion 14 to display a plurality of other print patterns that are different from a print pattern added to image data, and lets the user select a desired print pattern out of the plurality of other print patterns. For example, when the user specifies an area having a print pattern the user want to change among areas having individual hues (i.e., individual print patterns) in the image data on preview display, candidates for selectable print patterns are displayed on the display portion 14.

### Second Embodiment

In the above first embodiment, description is made of a case where the image processing portion 12 of the MFP 1 executes the print pattern conversion process of the present invention. The print pattern conversion process, however, may be executed by a printer driver of the PC 2. This embodiment will then be described referring to the above FIGS. 1 to 5.

In FIG. 1, the PC 2 includes an image forming portion 21 that is application software capable of multicolor image generation, a printer driver 22 that carries out an image process on image data generated by the image forming portion 21 and that issues an instruction of printing, a user input portion 23 having a keyboard, mouse, touch panel, etc., for user operation, a display portion 24 having a liquid crystal display capable of displaying various information on print preview, etc., a memory 25 provided as a hard disc, etc., that has stored thereon image data, etc., a control portion 26 that has a CPU, memory, etc., that control the overall operation of the PC 2, and a network interface 27 that is connected to the network 3 provided as a LAN, the Internet, etc., for outputting image data to the MFP 1.

Description will be made of a case where a color-reduced image is printed out of the original image data because of user setting, toner shortage in the MFP 1, etc. In this case, image data generated by the image forming portion 21 is color image data, and image data to be printed by a print instruction from the printer driver 22 is monochrome image data or color image data created by color reduction from the original image data.

Similar to the main feature of the MFP 1, the main feature of the PC 2 of the present invention is that when monochromatic parts having the same hue or similar hues are present at a plurality of spots, the PC 2 sets user-desiring print patterns for the monochromatic parts when printing out a color-reduced image out of a color image.

To offer its configuration, the PC 2 includes the image forming portion 21 equivalent to an image forming portion that generates image data, the printer driver 22 equivalent to a print instructing portion that issues an instruction of printing generated image data, a print pattern setting portion 224 equivalent to a print pattern setting portion that sets a user-desiring print pattern for each color, a print pattern conversion portion 225 equivalent to a print pattern conversion portion that carries out conversion into a print pattern set by the print pattern setting portion 224 for each color composing the image data having undergone a gradation change when printing is carried out at a gradation different from that of image data generated by the image forming portion 21, and the display portion 24 that displays a preview of the image data converted by the print pattern conversion portion 225. The printer driver 22 also functions as a print execution instructing portion that lets the user give an instruction on whether or not to execute printing of the image data after preview display by the display portion 24 or test printing by the MFP 1 is carried out.

When the user gives an instruction to execute printing, the printer driver 22 causes the MFP 1 to start an image data print process with print patterns resulting from conversion by the print pattern conversion portion 225. When the user does not give an instruction to execute printing, on the other hand, the print pattern setting portion 224 causes the display portion 24 to display a plurality of other print patterns different from a print pattern added to the image data to let the user select a desired print pattern out of the plurality of other print patterns.

The printer driver 22 has a print data generating portion 221, a data determining portion 222, and a warning portion 223, and also has the above print pattern setting portion 224 and print pattern conversion portion 225. The data determining portion 222 has a hue calculating portion 222a and an area dimension determining portion 222b.

The print data generating portion 221 converts color image data generated by the image forming portion 21 into printable data, and carries out a prescribed color-reducing process on the image data. Through this color-reducing process, each of hues composing the color image data is converted into, for example, any one of hues of C, M, Y, K, R, G, and B. The resulting image data is color-reduced image data.

The data determining portion 222 determines whether areas having specific colors and given dimensions are present at a plurality of spots in color-reduced image data created by color reduction from input image data. For example, when specific colors are C, M, Y, K, R, G, and B, different print patterns are assigned to each of these specific colors, as shown in FIG. 2. When two areas having different hues of R and B are generated as a result of reducing the input image data in color, both areas become indistinguishable if the luminance elements of both areas are the same. Converting the areas having hues of R and B into different print patterns, however, facilitates distinguishing one area from another.

When determining through the above determination process that areas having specific colors and given dimensions are present at a plurality of spots in color-reduced image data, the data determining portion 222 instructs the print pattern conversion portion 225 to carry out a process of converting each of the areas into a print pattern corresponding to each color of the area.

The hue calculating portion 222a calculates in pixels each of hues (e.g., C, M, Y, K, R, G, and B) contained in color-reduced image data resulting from color reduction.

The area dimension determining portion 222b calculates the dimension of each hue calculated by the hue calculating portion 222a. The area dimension determining portion 222b has a counting portion (not shown) that counts number of pixels of each hue composing color-reduced image data, and calculates the dimension of each hue based on number of pixels counted by the counting portion.

The data determining portion 222 excludes an image area that is determined to be a nature image including a person and scenery, from the subject of a print pattern conversion process. Specifically, when image data generated by the image forming portion 21 represents a nature image including a person and scenery, the print pattern conversion portion 225 does not carry out the process of conversion into a print pattern on a monochromatic area in color-reduced image data created by color reduction from that nature image.

The warning portion 223 outputs a warning indication on the display portion 24 when the data determining portion 222 issues an instruction of execution of the print pattern conversion process.

Receiving the instruction of execution of the print pattern conversion process from the data determining portion 222, the print pattern conversion portion 225 replaces a colored area to be converted into a print pattern with the corresponding print pattern. At this time, the print pattern replaces the area after being changed in color in adjustment to output following color reduction.

The memory 25 has stored thereon setting information 251 on setting of a print pattern, and a plurality of print pattern data 252 available for printing by a print instruction. Upon carrying out the process of conversion into a print pattern, the printer driver 22 refers to the setting information 251 and print pattern data 252 stored on the memory 25, and carries out conversion into a print pattern that corresponds to each color of color-reduced image data.

In FIG. 2, a threshold for “small dimension”, that for “medium dimension”, and that for “large dimension” on the print pattern conversion table are determined to be, for example, 10 pixels or more to less than 50 pixels, 50 pixels or more to less than 100 pixels, and 100 pixels or more, respectively, and the determined thresholds are included in the setting information 251. Areas to be converted into print patterns are assumed. The assumed areas consist of an area R1 having a hue of R (red) and a dimension of 150 pixels, an area R2 having a hue of R (red) and a dimension of 70 pixels, and an area B1 having a hue of B (blue) and a dimension of 30 pixels. In this case, according to the setting of the print pattern conversion table of FIG. 2, the print pattern #25 is selected for the area R1, the print pattern #15 is selected for the area R2, and the print pattern #17 is selected for the area B1.

In this manner, a print pattern can be set on the print pattern conversion table in correspondence to the dimension of each color composing color-reduced image data. This setting process is carried out by the print pattern setting portion 224 of FIG. 1. Following user operation, the print pattern setting portion 224 causes the display portion 24 to display the print pattern conversion table, and lets the user select a print pattern in correspondence to the dimension of each color of the color-reduced image data. In user selection, if selectable print patterns are displayed on the display portion 24, the user is able to select a desired print pattern easily and quickly, which is preferable. Based on a user selection result, the print pattern setting portion 224 rewrites the contents of the print pattern conversion table and sets a print pattern on the table.

On the print pattern conversion table, a different print pattern may be set according to the number of reduced colors in color-reduced image data. Similar to the above case, this setting process is carried out by the print pattern setting portion 224. Following user operation, the print pattern setting portion 224 causes the display portion 24 to display the print pattern conversion table, and lets the user select a different print pattern in correspondence to the number of reduced colors in the color-reduced image data. Based on a user selection result, the print pattern setting portion 224 rewrites the contents of the print pattern conversion table and sets a print pattern on the table. In this case, for example, a threshold is set for “small number of reduced color”, for “medium number of reduced color”, and for “large number of reduced color”, instead of being set for “small dimension”, for “medium dimension”, and for “large dimension” shown in FIG. 2, on the print pattern conversion table. A different print pattern is set for each of “small number of reduced color”, “medium number of reduced color”, and “large number of reduced color” in correspondence to each color of the color-reduced image data.

Referring to FIG. 1, the display portion 24 incorporated in the PC 2 has a function of displaying a preview of image data that is converted by the print pattern conversion portion 225. This allows the user to confirm print patterns of the image data through the preview displayed by the display portion 24 or test printing by the MFP 1 before execution of a process of printing the image data to which the print patterns are added.

As described above, the PC 2 has the print execution instructing portion that lets the user give an instruction on whether or not to execute printing of image data after preview display by the display portion 24 or test printing by the MFP is carried out. The print execution instructing portion is activated by the printer driver 22, displaying the screen that prompts the user to make a confirmation on whether or not to execute printing, as shown in FIG. 5. When the printer driver 22 issues an instruction to execute printing, the MFP 1 starts an image data printing process.

When the printer driver 22 does not issue an instruction to execute printing, the print pattern setting portion 224 causes the display portion 24 to display a plurality of other print patterns that are different from a print pattern added to image data, and lets the user select a desired print pattern out of the plurality of other print patterns. For example, when the user specifies an area having a print pattern the user want to change among areas having individual hues (i.e., individual print patterns) in the image data on preview display, candidates for selectable print patterns are displayed on the display portion 24.

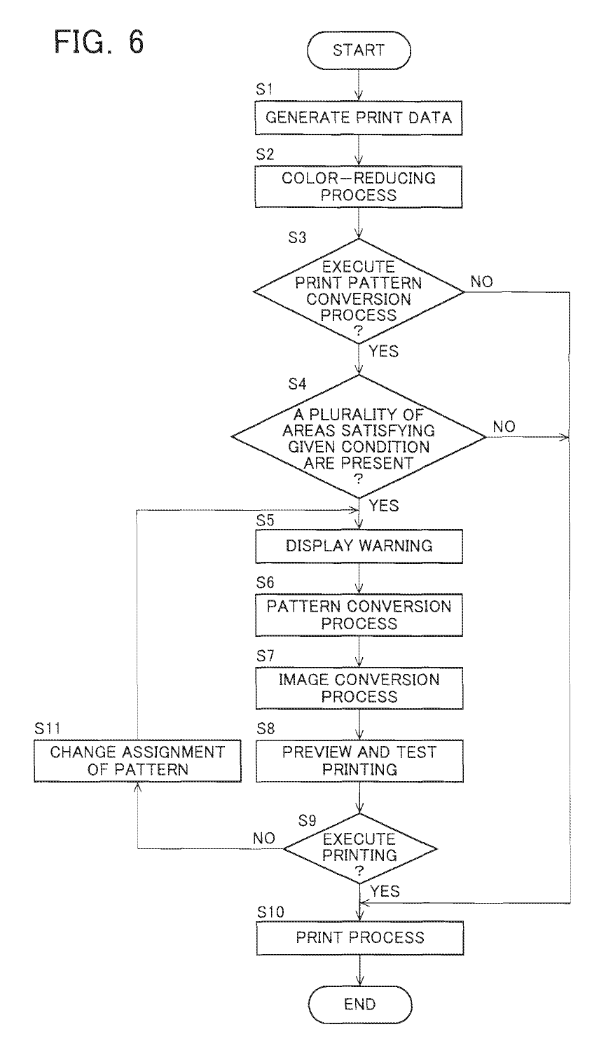

FIG. 6 is a flowchart for explaining an example of the image forming method carried out by the MFP 1 of the present invention. While implementation of the present invention by a single unit of the MFP 1 is described in this example, the same image forming method applies to a case where the present invention is implemented by the printer driver 22 of the PC 2. In such a case, the PC 2 carries out the image generating process of the present invention and the MFP 1 carries out the print process. Specifically, image data generated by the printer driver 22 is sent to the MFP 1 via the network interface 27, and is printed out at the printing portion 16.

Referring to FIG. 6, image data read by the original reading portion 11 is sent to the image processing portion 12. The image data generating portion 121 generates printable image data based on input image data from the image processing portion 12 (step S1). When the original image data have to be printed out as a color-reduced image for the reason of user setting, toner shortage in the MFP 1, etc., the image data generating portion 121 executes a setting-based color-reducing process to generate image data (step S2).

The image processing portion 12 then determines whether or not to execute the print pattern conversion process, based on the setting information 151 (step S3). When no execution of the print pattern conversion process is set in the setting information 151 (NO at step S3), the image data is sent to the printing portion 16, which starts printing the image data immediately (step S10). When execution of the print pattern conversion process is set in the setting information 151 at step S3 (YES at step S3), color-reduced image data having undergone the color-reducing process is sent to the data determining portion 122.

The data determining portion 122 determines whether a plurality of areas satisfying given conditions are present in the color-reduced image data having undergone the color-reducing process (step S4). When the plurality of areas satisfying the given conditions are not present (NO at step S4), the process flow proceeds to step S10. When the plurality of areas satisfying the given conditions are present at step 4 (YES at step S4), the warning portion 123 generates a message of execution of the print pattern conversion process, which message is displayed on the display portion 14 as a notification to the user (step S5). The areas satisfying the given conditions are the monochromatic areas each having a given dimension or larger dimension and being recognized not to be a nature image. Conversion reservation flags are set up for these areas to generate area information for execution of the print pattern conversion process.

Then, the print pattern conversion portion 125 converts each of the conversion-determined areas in the color-reduced image data separately to each corresponding print pattern data 152, based on the area information from the data determining portion 122 and the setting information 151 (step S6), thus generates converted image data (step S7).

The image data generated by the print pattern conversion portion 125 is displayed as a preview at the display portion 14, based on the setting information 151, or is subjected to test printing at the printing portion 16, based on the setting information 151 (step S8).

Subsequently, the image processing portion 12 causes the display portion 14 to display a message for letting the user make a choice on whether or not to continue printing, and determines whether the user has given an instruction of continuing printing by operating the user input portion 13 (step S9). When the user has given the instruction of continuing printing (YES at step S9), the printing portion 16 executes printing (step S10). When the user has made a choice of not continuing printing at step S9 (NO at step S9), the image processing portion 12 refers again to the setting information 151, and causes the display portion 14 to display a plurality of other print patterns extracted from the print pattern data 152. The user selects a desired print pattern out of the plurality of other print patterns (step S11), and the process flow returns to step S5, from which the same process is repeated. Hence the user is able to restructure print patterns until the user obtains a desired print result.

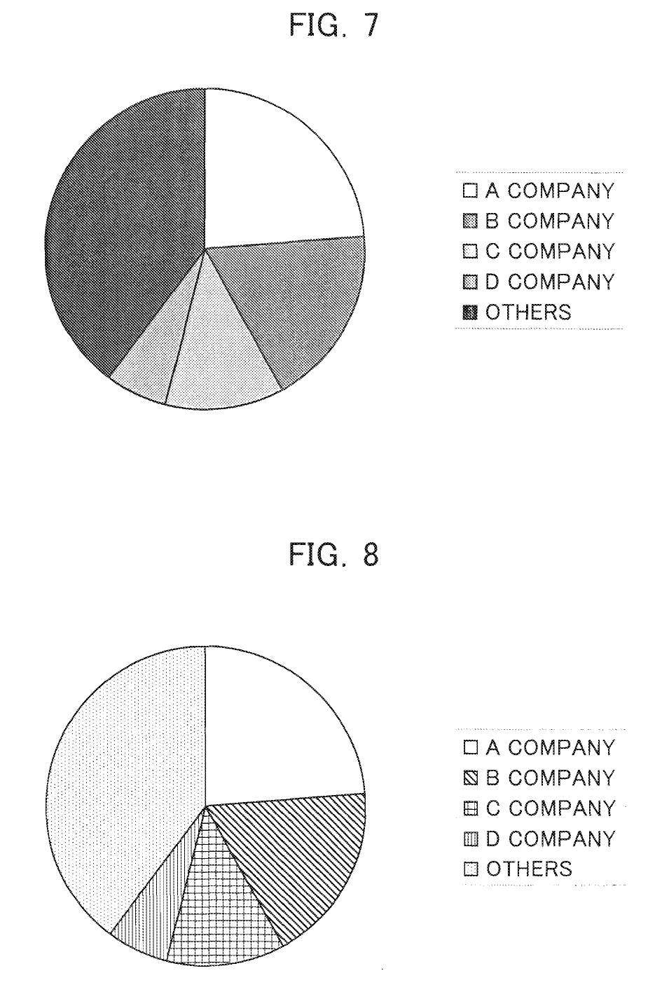

FIG. 7 depicts an example of a case where a color image is reduced in color to a gray scale image. FIG. 8 depicts an example of image data that is output as a result of assigning print patterns to the gray scale image of FIG. 7 and converting the gray scale image.

Referring to FIG. 7, as a result of the color-reducing process, an area “B company” becomes closer in thickness to an area “others”, and an area “C company” becomes closer in thickness to an area “D company”. This makes the areas indistinguishable from each other. Adding a print pattern to each area, however, facilitates distinguishing one area from another in the areas of “A company” to “others”, as shown in FIG. 8.

As described above, according to the present invention, when monochromatic parts having the same color or similar hues are present at a plurality of spots, user-desiring print patterns can be set for the monochromatic parts when color-reducing printing of a color image is carried out. This enables output of a printed matter with rich expressiveness even in monochrome printing or in color-reducing printing of the original color image.

Even in a case where a color image intentionally divided based on color by a user is printed into a monochrome image or into a color-reduced color image made out of the original color image and the output image turn out to be indistinguishable in color-based division, the user is bale to form a desired image requiring color-based distinction by adding a print pattern to the original image and outputting the image.

The present invention offers the following effects.

According to the present invention, when monochromatic parts having the same color or similar hues are present at a plurality of spots, user-desiring print patterns can be set for the monochromatic parts when color-reducing printing of a color image is carried out. This enables output of a printed matter with rich expressiveness even in monochrome printing or in color-reducing printing of the original color image.

Even in a case where a color image intentionally divided based on color by a user is printed into a monochrome image or into a color-reduced color image made out of the original color image and the output image turn out to be indistinguishable in color-based division, the user is bale to form a desired image requiring color-based distinction by adding a print pattern to the original image and outputting the image.

1. An image forming apparatus having an input portion that inputs image data and a printing portion that prints the input image data, the image forming apparatus comprising:
a print pattern setting portion that sets a print pattern available for user setting for each color;
a print pattern conversion portion that carries out conversion into a print pattern set by the print pattern setting portion for each color composing the image data having undergone a gradation change when printing is carried out at a gradation different from that of image data input by the input portion;
a display portion that displays a preview of the image data converted by the print pattern conversion portion; and
a print execution instructing portion that lets a user give an instruction on whether or not to execute printing of the image data after preview display by the display portion or test printing by the printing portion is carried out, wherein
when an instruction to execute printing is given, the printing portion starts a process of printing the image data, and wherein
when no instruction to execute printing is given, the print pattern setting portion causes the display portion to display a plurality of other print patterns different from a print pattern added to the image data to let the user select a desired print pattern out of the plurality of other print patterns.

2. The image forming apparatus as defined in claim 1, wherein
image data input by the input portion represents a color image, and image data printed by the printing portion represents a monochrome image or a color image created by color reduction from the color image.

3. The image forming apparatus as defined in claim 1 or 2, wherein
when a plurality of areas having specific colors and given dimensions or larger dimensions are present in color-reduced image data created by color reduction from image data input by the input portion, the print pattern conversion portion carries out conversion into a print pattern set by the print pattern setting portion for each of colors of the areas.

4. The image forming apparatus as defined in claim 3, comprising a counting portion that counts number of pixels of each color composing the color-reduced image data, wherein
a dimension of the each color is calculated based on number of pixels counted by the counting portion.

5. The image forming apparatus as defined in claim 3, wherein
the print pattern setting portion sets a print pattern according to a dimension of each color composing the color-reduced image data.

6. The image forming apparatus as defined in claim 3, wherein
the print pattern setting portion sets a different print pattern according to number of reduced colors in the color-reduced image data.

7. The image forming apparatus as defined in claim 1 or 2, wherein
when image data input by the input portion represents a nature image including a person and scenery, the print pattern conversion portion does not carry out a process of conversion into a print pattern on a monochromatic area in color-reduced image data created by color reduction from the nature image.

8. An information processing apparatus connectible to an image forming apparatus that prints image data, the information processing apparatus comprising:
an image forming portion that generates image data;
a print instructing portion that instructs the image forming apparatus to print the generated image data;
a print pattern setting portion that sets a print pattern available for user setting for each color;
a print pattern conversion portion that carries out conversion into a print pattern set by the print pattern setting portion for each color composing the image data having undergone a gradation change when a print instruction is issued for printing at a gradation different from that of image data generated by the image forming portion;
a display portion that displays a preview of the image data converted by the print pattern conversion portion; and
a print execution instructing portion that lets a user give an instruction on whether or not to execute printing of the image data after preview display by the display portion or test printing by the image forming apparatus is carried out, wherein
when an instruction to execute printing is given, the print instructing portion causes the image forming apparatus to start an process of printing the image data, and wherein
when no instruction to execute printing is given, the print pattern setting portion causes the display portion to display a plurality of other print patterns different from a print pattern added to the image data to let the user select a desired print pattern out of the plurality of other print patterns.

9. The information processing apparatus as defined in claim 8, wherein
image data generated by the image forming portion represents a color image, and image data to be printed by an instruction from the print instructing portion represents a monochrome image or a color image created by color reduction from the color image.

10. The information processing apparatus as defined in claim 8 or 9, wherein
when a plurality of areas having specific colors and given dimensions or larger dimensions are present in color-reduced image data created by color reduction from image data generated by the image forming portion, the print pattern conversion portion carries out conversion into a print pattern set by the print pattern setting portion for each of colors of the areas.

11. The information processing apparatus as defined in claim 10, comprising a counting portion that counts number of pixels of each color composing the color-reduced image data, wherein
a dimension of the each color is calculated based on number of pixels counted by the counting portion.

12. The information processing apparatus as defined in claim 10, wherein
the print pattern setting portion sets a different print pattern according to a dimension of each color composing the color-reduced image data.

13. The information processing apparatus as defined in claim 10, wherein
the print pattern setting portion sets a different print pattern according to number of reduced colors in the color-reduced image data.

14. The information processing apparatus as defined in claim 8 or 9, wherein
when image data generated by the image forming portion represents a nature image including a person and scenery, the print pattern conversion portion does not carry out a process of conversion into a print pattern on a monochromatic area in color-reduced image data created by color reduction from the nature image.

15. An image forming method carried out by an image forming apparatus that inputs image data and prints the input image data, the image forming method comprising:
a print pattern setting step of setting a print pattern available for user setting for each color;
a print pattern conversion step of carrying out conversion into a print pattern set at the print pattern setting step for each color composing the image data having undergone a gradation change, when printing is carried out at a gradation different from that of the input image data;
a display step of displaying a preview of the image data converted at the print pattern conversion step; and
a print execution instructing step of letting a user give an instruction on whether or not to execute printing of the image data after display of a preview of the image data or test printing of the image data is carried out, wherein
when an instruction to execute printing is given, the method causes the image forming apparatus to start a process of printing the image data, and wherein
when no instruction to execute printing is given, the method causes the image forming apparatus to display a plurality of other print patterns different from a print pattern added to the image data to let the user select a desired print pattern out of the plurality of other print patterns.
